(19) United States
(12) Patent Application Publication
(10) Pub. No.: US 2011/0085592 A1
(43) Pub. Date: Apr. 14, 2011

(54) VIDEO FRAME LOSS RECOVERY SCHEME

(76) Inventors: Ching-Lung CHANG, Touliu (TW); Fang-Chieh Chen, Touliu (TW)

(21) Appl. No.: 12/577,817

(22) Filed: Oct. 13, 2009

(51) Int. Cl. H04N 7/32

(52) U.S. Cl. 375/240.12; 375/E07.246

(57) ABSTRACT

A video frame loss recovery scheme essentially belongs to a loss packet in a low overhead and low complicated recovery scheme and serves to protect P-frames of a group of pictures (GOP). Namely, if a P-frame of the same group of pictures loses during the transmission, a compensation frame could be applied to serve and recovered as a lost P-frame, thereby promoting to a preferable video presenting performance of a receiver.

### BACKGROUND OF THE INVENTION

1. Field of the Invention

The present invention relates to a video frame loss recovery scheme.

2. Description of the Related Art

Following the development of digitization, the real-time streaming video has been a popular issue in the internet technology. However, it is common that the video incurs an unexpected interference during the image transmission, such as the varied bandwidth, and the image data would accordingly lose. Herein, the main means at present to solve the influence of a loss packet on a video recovery of a receiver are described below:
1. A concealment of the lost image data by decoding: this technique is called Error Concealment. Namely, when the data is lost during the transmission of an image block through the network, a decoder could forecast according to the relationship between the neighboring blocks so as to conceal from the image block. Wherein, different degrees of image complications result in discrete concealment efficiencies.
2. A loss packet recovery by packet: there are three main means of this solution: Forward Error Correction (FEC), Auto Repeat Request (ARQ), and hybrid; wherein:

Forward Error Correction, e.g. the application of the RS code, adds some redundancy data into the effect data to execute the complicated RS coding. Wherein, when part of the data is lost during the network transmission, the receiver would employ the redundancy data to execute the RS decoding with the received effect data so as to recover the lost data. However, some disadvantages exist in this means: (1) The lost data might be too many to be recovered. (2) The encoding and decoding operation is highly complicated. (3) This means needs the redundancy data to serve as a protector.

Auto Repeat Request (ARQ) is like the Select Repeat Automatic Repeat Request. Namely, when a transmitter consecutively transmits multiple packets to a receiver, which may discover an error in one of the data packet, the receiver would inform the transmitter of the specific error packet. Therefore, the transmitter could simply transmit the said error packet. However, this means requires considerable memories in the transmitter and the receiver for saving the transmitted and non-transmitted data. Concurrently, if this means is applied to the congested network, it may incur large Round Trip Time delay between the transmitter and receiver for recovering the lost packets. At the same time, the retransmission would increase phenomenon of network congestion.

The hybrid integrates the characteristics of the Forward Error Correction (FEC) and the Auto Repeat Request (ARQ). Wherein, a transmitter would transmit the effect data for being encoded by the FEC so as to continuously transmit multiple packets to a receiver. Whereby, when the receiver detects any error existing in any data, the FEC would be previously executed and decoded for trying to recover the lost data. If the lost data is unable to be recovered, the transmitter would be informed to retransmit the said lost data again. In this means, the FEC decoding could decrease times of round trip time for recovering the loss packets, and concurrently, if the lost packet can't be recovered by the FEC, the ARQ is applied to recover the lost packet. However, if the lost packets amount to a large number, the hybrid scheme would possess all of the deficiencies in the FEC and the ARQ.

### SUMMARY OF THE INVENTION

The object of the present invention is to provide a video frame loss recovery scheme comprising a transmitter and a receiver. Wherein, the transmitter transmits at least one group of pictures (GOP) through an image encoder, and the group of pictures includes at least one P-frame. Moreover, the image encoder couples to an XOR summation device, and the P-frame transmits into the XOR summation device to generate a compensation frame. Concurrently, the said group of pictures and the compensation frame are transmitted to the receiver together. While any one of the P-frames belong to the same group of pictures loses during the transmission, the compensation frame could be directly to recover the lost P-frame, i.e., the compensation frame and the received P-frame that has not been lost could be operated through an XOR decoding device to recover the lost P-frame. Thereby, an image presenting performance of the receiver could be promoted.

### BRIEF DESCRIPTION OF THE DRAWINGS

FIG. 1 is a schematic view showing the present invention; and

FIG. 2 is a block diagram showing the present invention.

### DETAILED DESCRIPTION OF THE PREFERRED EMBODIMENTS

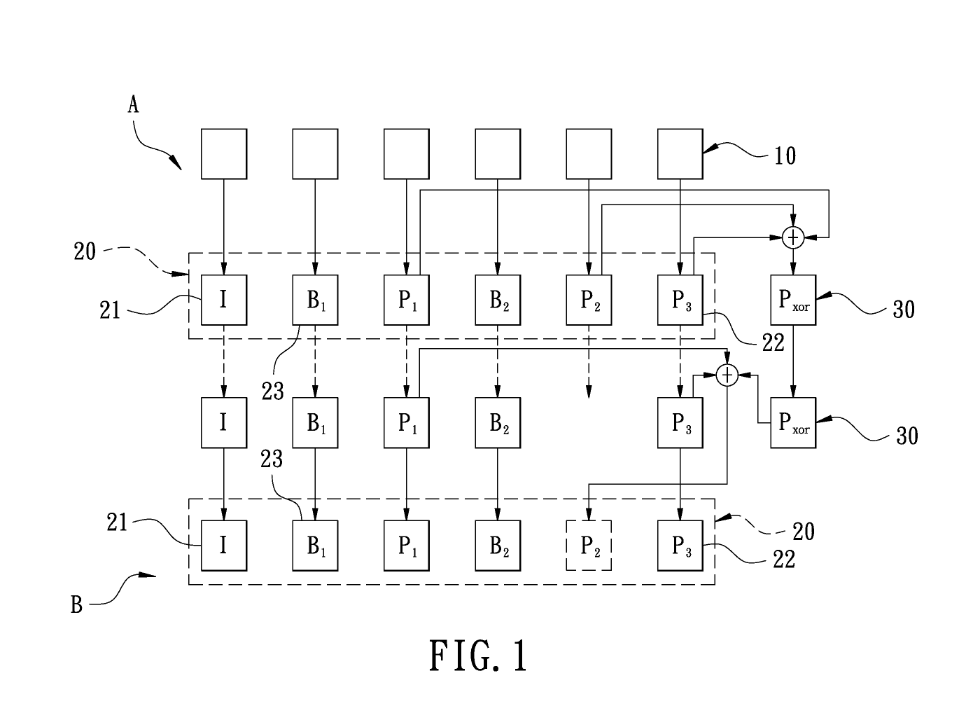

First, referring to FIG. 1 showing a schematic view of the present invention comprises a transmitter A and a receiver B. Wherein, the transmitter A compresses a plurality of image data 10 into a serial of group of pictures (GOP) 20. Here in this embodiment, we adopt one group of pictures 20 to describe as following. The group of pictures 20 includes an I-frame 21, a plurality of P-frames 22, and a plurality of B-frames 23. The I-frame 21 is formed by self-compressing according to the image data 10 thereof, the P-frame 22 could be compressed according to the previous image data 10 or the previous P-frame 22, and the B-frame 23 could be compressed according to the previous and the subsequent image data 10. Concurrently, those P-frames 22 integrally form a compensation frame 30 through an XOR logic operation. The group of pictures 20 and the compensation frame 30 are transmitted to the receiver B with each other. Wherein, if merely one P-frame 22 in the same group of pictures 20 loses in time of transmission, the compensation frame 30 and the other P-frame 22 that has not been lost could be executed to the XOR logic operation so as to recover the lost P-frame 22. Whereby, the receiver B could receive a complete group of pictures 20. On the other hand, if there is only one P-frame 22 in the same group of pictures 20, the compensation frame 30 could be directly served as the lost P-frame 22.

The video frame loss recovery scheme is accomplished by showing the following respective algorithms of the transmitter and the receiver calculated as:

### The Image Transmitter:

$${R}_{e} = max\_length \{ {P}_{1} , {P}_{2} , {P}_{3} , … {P}_{k - n - 1} \}$$

$$Δ {R}_{i} = {R}_{e} - f ( {P}_{i} ) , i = \{ 1 , 2 , 3 , … , k - n - 1 \}$$

$${P}_{i} = {P}_{i} * {2}^{Δ {R}_{i}} , i = \{ 1 , 2 , 3 , … , k - n - 1 \}$$

$${P}_{xor} = {\sum }_{i = 1}^{k - n - 1} {P}_{i}$$

### The Image Receiver:

$${R}_{d} = f ( {P}_{xor} )$$

$$Δ {R}_{i} = {R}_{d} - f ( {P}_{i} ) , i = \{ 1 , 2 , 3 , … , k - n - 1 \} - j$$

$${P}_{i} = {P}_{i} * {2}^{Δ {R}_{i}} , i = \{ 1 , 2 , 3 , … , k - n - 1 \} - j$$

$${P}_{j} = {\sum }_{i = \{ 1 , 2 , 3 , … , k - n - 1 , xor \} - j} {P}_{i}$$

As to the transmitter A, the algorithm thereof would decide the longest data length of the P-frames 22, which is presented by Rₑ, and wherein the P-frames 22 would be presented by P1, P2, P3, . . . Pk−n−1. K is directed to the frame number in the group of pictures 20, n is directed to the number of the B-frames 23. Moreover, the longest data length Rₑ among the P-frame 22 in the group of pictures 20 is applied to minus a function f(Pᵢ), and the function f(Pᵢ) includes the P-frames 22 presented by Pᵢ. Moreover, i is directed to the sequence numbers of the P-frames 22 in the group of pictures 20, and the function f(Pᵢ) could acquire the data lengths of the respective P-frames 22. Accordingly, the length differences between the longest data length among the P-frames 22 and data length of each P-frame 22 could be worked out and presented by ΔRᵢ. After that, the data lengths of the P-frames 22 should be compensated to the identical value. Further, the P-frames 22 would collectively employ the XOR logic operation to acquire the compensation frame 30, which is presented by Pₓₒᵣ.

As to the image receiver B, the algorithm thereof would previously decide the data length of the compensation frame 30, which is presented by R_{d}. Concurrently, the data length of the compensation frame 30 minus the data length of each P-frame 22 achieves the differences between the data lengths of the respective P-frames 22 and the compensation frame 30, which is presented by ΔRᵢ. Wherein, K is directed to the frame number in the group of pictures 20, n is directed to the frame number of the B-frames 23, j is directed to the sequence number of the lost P-frame 22, and i is directed to the sequence number of the non-lost P-frame 22. After that, the data lengths of the P-frames 22 should be compensated to the identical value. Accordingly, the non-lost P-frame 22 and the compensation frame 30 can be mutually calculated by the XOR logic operation to achieve the lost P-frame 22, which is presented by Pᵢ.

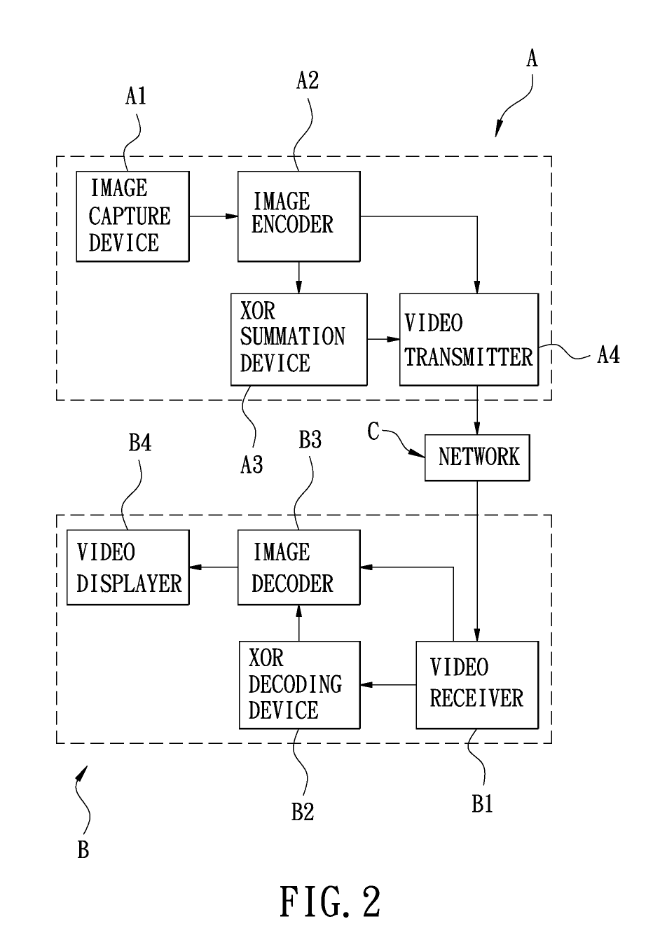

Referring to FIG. 2 shows the block diagram of the present invention. The transmitter A includes an image capture device A1, an image encoder A2, an XOR summation device A3, and a video transmitter A4. Wherein, the image capture device A1 couples to the image encoder A2, and the image encoder A2 further couples to the XOR summation device A3 and the video transmitter A4, respectively. The XOR summation device A3 further couples to the video transmitter A4. In addition, the receiver B includes a video receiver B1, an XOR decoding device B2, an image decoder B3, and an video displayer B4. Wherein, the video receiver B1 respectively couples to the XOR decoding device B2 and the image decoder B3, the XOR decoding device B2 further couples to the image decoder B3, and the image decoder B3 further couples to the video displayer B4. The abovementioned devices are operated as follows: The image capture device A1 could capture the image data 10 that has not been encoded, so that the image data 10 could transmit into the image encoder A2 to generate the group of pictures 20. Namely, the image encoder A2 receives the non-encoded image data 10 through the image capture device A1 to execute the code MPEG4 compression to the non-encoded image data 10 according to the related encoding parameters (such as the dimension of the group of pictures 20), so that the I-frame 21, the P-frames 22, and the B-frames 23 could be correspondingly generated. The image encoder A2 in this preferred embodiment could alternatively adopt other compressing codes, such as MPEG2, H.263, H.264, and etc. Moreover, the group of pictures 20 further transmits the coupling into the video transmitter A4, and the image encoder A2 merely transmits the P-frames 22 into the XOR decoding device A3. Additionally, the XOR summation device A3 could correspondingly generate the compensation frame 30 through the XOR logic operation for the compensation frame 30 to further transmit into the video transmitter A4. Whereby, the video transmitter A4 would package the I-frame 21, the P-frames 22, the B-frames 23, and the compensation frame 30 into a network packet for being streamingly transmitted to the video receiver B1 by a network C, and thence the video receiver B1 would transmit the group of pictures 20 into the video decoder B3. The video receiver B1 further transmits the P-frame 22 and the compensation frame 30 into the XOR decoding device B2 for the video receiver B1 to judge if the P-frames 22 are lost. Wherein, when only one P-frame 22 loses and the compensation frame 30 successfully receives, the XOR decoding device B2 would be employed to recover the lost P-frame 22 from the calculating of the compensation frame 30 and the non-lost P-frame 22 through the XOR logic operation. Thereby, the said lost P-frame 22 could be transmitted into the image decoder B3 to execute decoding, and the image decoder B3 would transmit the group of pictures 20 to the video displayer B4 for a preferable image presenting performance.

I claim:

1. A video frame loss recovery scheme comprising at least one transmitter and at least one receiver; wherein, said transmitter transmitting at least one group of pictures through an image encoder, and said group of pictures comprising at least one P-frame; said image encoder further coupling to an XOR summation device, and said P-frame transmitting into said XOR summation device to generate a compensation frame; said group of pictures and said compensation frame being transmitted to said receiver together, whereby while any one of said P-frame in said same group of pictures loses during a transmission, said compensation frame could be directly served as a lost P-frame, or said compensation frame and a non-lost P-frame could be calculated through an XOR decoding device, from which said lost P-frame could be recovered for promoting an video performance of said receiver.

2. The video frame loss recovery scheme as claimed in claim 1, wherein, said group of pictures is compressed by a plurality of image data and comprising at least one P-frame.

3. The video frame loss recovery scheme as claimed in claim 2, wherein, said group of pictures further includes an I-frame, and said I-frame could compress itself according to an image data thereof.

4. The video frame loss recovery scheme as claimed in claim 2, wherein, said group of pictures further includes at least one B-frame, and said B-frame is compressed according to the previous image data and the subsequent image data.

5. The video frame loss recovery scheme as claimed in claim 2, wherein, said P-frame is compressed according to the previous image data.

6. The video frame loss recovery scheme as claimed in claim 1, wherein, said transmitter further includes an image capture device and a video transmitter; said image capture device couples to said image encoder, and said image encoder respectively couples to said XOR summation device and said video transmitter; said XOR summation device further couples to said video transmitter; said image capture device could capture an original non-encoded image data, and said original image data could transmit into said image encoder to generate said group of pictures, so that said group of pictures could further transmit into said video transmitter; said image encoder merely transmits said P-frames into said XOR summation device for said XOR summation device to correspondingly generate said compensation frame, so that said compensation frame could additionally transmit into said video transmitter.

7. The video frame loss recovery scheme as claimed in claim 1, wherein, said receiver further includes a video receiver, an image decoder, and an video displayer; said video receiver respectively couples to said XOR decoding device and said image decoder; said XOR decoding device further couples to said image decoder, and said image decoder couples to said video displayer; said video receiver could receive said group of pictures and said compensation frame, and said video receiver transmits said group of pictures into video decoder; said video receiver transmits said P-frame and said compensation frame into said XOR decoding device; said XOR decoding device could judge if said P-frames are lost and recover said lost P-frame while any one of said P-frames is lost, so that said lost P-frame could be transmitted into said image decoder to proceed to decode, and a complete group of pictures could be transmitted from said image decoder to said video displayer.

8. The video frame loss recovery scheme as claimed in claim 1, wherein, said transmitter and said receiver are communicated through a network.

9. The video frame loss recovery scheme as claimed in claim 1, wherein, said image encoder could execute either a compressing code of MPEG2, MPEG4, H.263, or H.264.
